(19) United States
(12) Patent Application Publication
(10) Pub. No.: US 2024/0020977 A1
(43) Pub. Date: Jan. 18, 2024

(54) SYSTEM AND METHOD FOR MULTIMODAL VIDEO SEGMENTATION IN MULTI-SPEAKER SCENARIO

(71) Applicant: PING AN TECHNOLOGY (SHENZHEN) CO., LTD., Shenzhen (CN)

(72) Inventors: Xinyi Wu, Palo Alto, CA (US); Tian Xia, Palo Alto, CA (US); Xinlu Yu, Palo Alto, CA (US); Ziyi Chen, Palo Alto, CA (US); Iek-Heng Chu, Palo Alto, CA (US); Sirui Xu, Palo Alto, CA (US); Mei Han, Palo Alto, CA (US); Jing Xiao, Palo Alto, CA (US); Peng Chang, Palo Alto, CA (US)

(73) Assignee: PING AN TECHNOLOGY (SHENZHEN) CO., LTD., Shenzhen (CN)

(21) Appl. No.: 17/867,667

(22) Filed: Jul. 18, 2022

(51) Int. Cl. G06V 20/40; G10L 17/18; G10L 17/02; G10L 17/14; G10L 25/60; G06V 40/16; G06F 40/284

(52) U.S. Cl. CPC G06V 20/49; G10L 17/18; G10L 17/02; G10L 17/14; G10L 25/60; G06V 40/172; G06V 40/161; G06F 40/284

(57) ABSTRACT

A system and method for multimodal video segmentation in a multi-speaker scenario are provided. A transcript of a video with a plurality of speakers is segmented into a plurality of sentences. Speaker change information is detected between each two adjacent sentences of the plurality of sentences based on at least one of audio content or visual content of the video. The video is segmented into a plurality of video clips based on the transcript of the video and the speaker change information.

### TECHNICAL FIELD

The present disclosure relates to video processing, and more particularly, to a system and method for performing multimodal video segmentation on a video with a plurality of speakers.

### BACKGROUND

Video clipping is a task that divides a video into meaningful and self-contained short clips. Each clip has relatively independent and complete content, and is output as a short video alone or used as material for subsequent processing. With the emergence of more and more videos from various sources, the demand for video clipping is also increasing. Traditional manual video clipping requires an editor to have certain professional video clipping knowledge. For example, the editor needs to watch the whole video, and then uses editing software to segment the video into clips according to the video content. This manual video clipping is time-consuming and labor-intensive especially when the number of videos to be clipped is large.

### SUMMARY

In one aspect, a system for multimodal video segmentation in a multi-speaker scenario is disclosed. The system includes a memory configured to store instructions and a processor coupled to the memory and configured to execute the instructions to perform a process. The process includes segmenting a transcript of a video with a plurality of speakers into a plurality of sentences. The process further includes detecting speaker change information between each two adjacent sentences of the plurality of sentences based on at least one of audio content or visual content of the video. The process further includes segmenting the video into a plurality of video clips based on the transcript of the video and the speaker change information.

In another aspect, a method for multimodal video segmentation in a multi-speaker scenario is disclosed. A transcript of a video with a plurality of speakers is segmented into a plurality of sentences. Speaker change information between each two adjacent sentences of the plurality of sentences is detected based on at least one of audio content or visual content of the video. The video is segmented into a plurality of video clips based on the transcript of the video and the speaker change information.

In yet another aspect, a non-transitory computer-readable storage medium is disclosed. The non-transitory computer-readable storage medium is configured to store instructions which, in response to an execution by a processor, cause the processor to perform a process. The process includes segmenting a transcript of a video with a plurality of speakers into a plurality of sentences. The process further includes detecting speaker change information between each two adjacent sentences of the plurality of sentences based on at least one of audio content or visual content of the video. The process further includes segmenting the video into a plurality of video clips based on the transcript of the video and the speaker change information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated herein and form a part of the specification, illustrate implementations of the present disclosure and, together with the description, further serve to explain the present disclosure and to enable a person skilled in the pertinent art to make and use the present disclosure.

FIG. 1 illustrates a block diagram of an exemplary operating environment for a system configured to perform multimodal video segmentation in a multi-speaker scenario, according to embodiments of the disclosure.

FIG. 2 is a schematic diagram illustrating an exemplary flow of performing multimodal video segmentation in a multi-speaker scenario, according to embodiments of the disclosure.

FIG. 3 illustrates a schematic diagram of audio-based speaker change detection, according to embodiments of the disclosure.

FIG. 4 illustrates a schematic diagram of vision-based speaker change detection, according to embodiments of the disclosure.

FIGS. 5A-5C are graphical representations illustrating an example of vision-based speaker change detection, according to embodiments of the disclosure.

FIG. 6 illustrates a schematic diagram of video segmentation based on speaker change information, according to embodiments of the disclosure.

FIG. 7 is a graphical representation illustrating exemplary performance of multimodal video segmentation in a multi-speaker scenario, according to embodiments of the disclosure.

FIG. 8 is a flowchart of an exemplary method for performing multimodal video segmentation in a multi-speaker scenario, according to embodiments of the disclosure.

FIG. 9 is a flowchart of another exemplary method for performing multimodal video segmentation in a multi-speaker scenario, according to embodiments of the disclosure.

Implementations of the present disclosure will be described with reference to the accompanying drawings.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Automatic video clipping is in demand with the popularity of short videos. Since each video comes with multiple modalities, the multimodal signals in the video can be used together to get maximum information out of the video. In a multi-speaker scenario, different speakers often interact with each other in the same video. An effective video clipping system needs to be able to differentiate the speakers in the video in order to better capture semantic information from the inter-speaker communication.

In this disclosure, a system and method for performing multimodal video segmentation in a multi-speaker scenario are provided. Specifically, the system and method disclosed herein can use textual, audio, and visual signals of a video to automatically generate high-quality short video clips from the video in an end-to-end manner. In particular, the system and method disclosed herein can detect speakers present in the video and determine speaker change information using both audio-based detection and vision-based detection. For example, the system and method disclosed herein can integrate sources of information from textual, audio, and visual modalities of the video to automatically detect speakers present in the video and determine speaker change information in the video. The system and method disclosed herein can segment the video into short video clips based on a transcript of the video and the speaker change information.

Consistent with the present disclosure, not only a textual source of a video is used for the segmentation of the video, but also audio content and visual content of the video are used to perform speaker identification in the video and to determine the speaker change information in the video. By identifying speaker boundaries, the system and method disclosed herein can extract semantic information from the textual modality more accurately and significantly improve the clipping quality in multi-speaker videos.

Consistent with the present disclosure, for a given input video, the system and method disclosed herein may firstly perform a text-based sentence segmentation to determine timestamps for sentence beginnings as well as sentence endings for the downstream speaker detection. Then, the system and method disclosed herein can utilize both an audio-based approach and a vision-based approach to detect speakers in the input video. The system and method disclosed herein can feed the detected speaker information into a clip segmentation model, which uses the detected speaker information and the transcript of the input video to predict clip boundary points for the input video. The input video can be segmented into video clips at the clip boundary points.

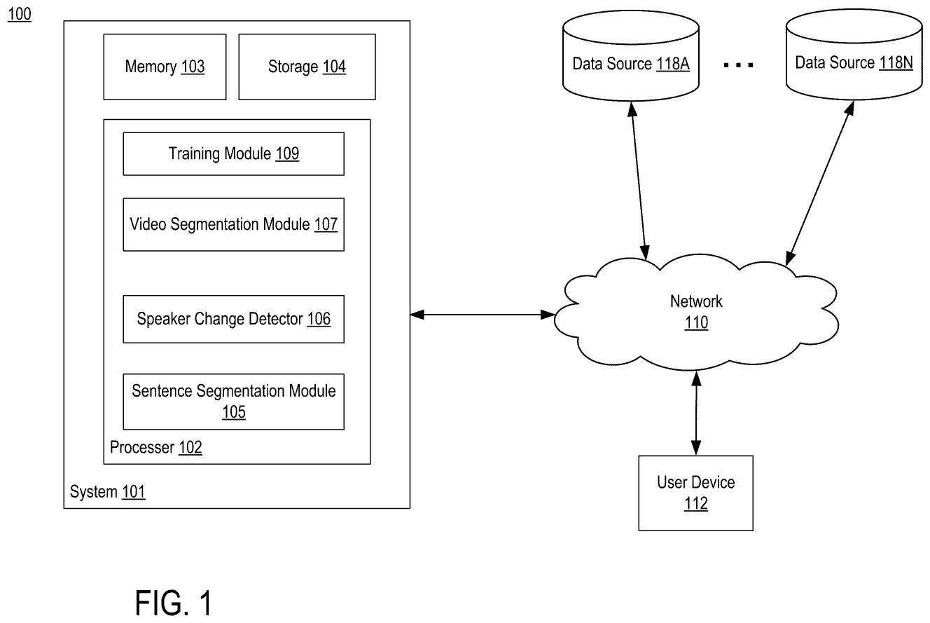

FIG. 1 illustrates an exemplary operating environment 100 for a system 101 configured to perform multimodal video segmentation in a multi-speaker scenario, according to embodiments of the disclosure. Operating environment 100 may include system 101, one or more data sources 118A, . . . , 118N (also referred to as data source 118 herein, individually or collectively), a user device 112, and any other suitable components. Components of operating environment 100 may be coupled to each other through a network 110.

In some embodiments, system 101 may be embodied on a computing device. The computing device can be, for example, a server, a desktop computer, a laptop computer, a tablet computer, or any other suitable electronic device including a processor and a memory. In some embodiments, system 101 may include a processor 102, a memory 103, and a storage 104. It is understood that system 101 may also include any other suitable components for performing functions described herein.

In some embodiments, system 101 may have different components in a single device, such as an integrated circuit (IC) chip, or separate devices with dedicated functions. For example, the IC may be implemented as an application-specific integrated circuit (ASIC) or a field-programmable gate array (FPGA). In some embodiments, one or more components of system 101 may be located in a cloud computing environment or may be alternatively in a single location or distributed locations. In some embodiments, components of system 101 may be in an integrated device or distributed at different locations but communicate with each other through network 110.

Processor 102 may include any appropriate type of general-purpose or special-purpose microprocessor, digital signal processor, microcontroller, and graphics processing unit (GPU). Processor 102 may include one or more hardware units (e.g., portion(s) of an integrated circuit) designed for use with other components or to execute part of a program. The program may be stored on a computer-readable medium, and when executed by processor 102, it may perform one or more functions disclosed herein. Processor 102 may be configured as a separate processor module dedicated to image processing. Alternatively, processor 102 may be configured as a shared processor module for performing other functions unrelated to image processing.

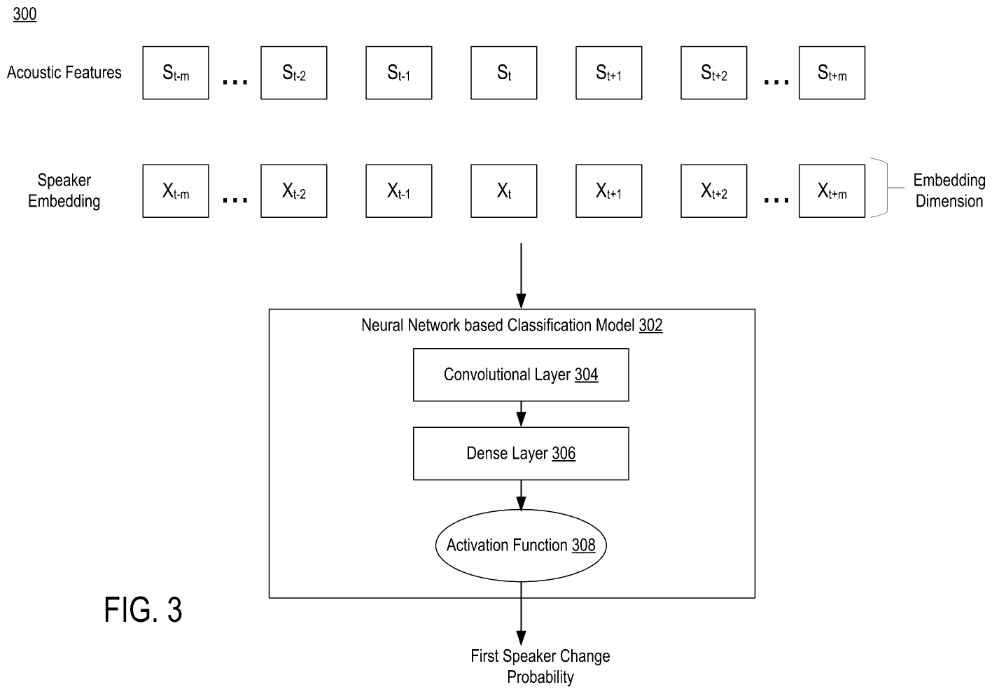

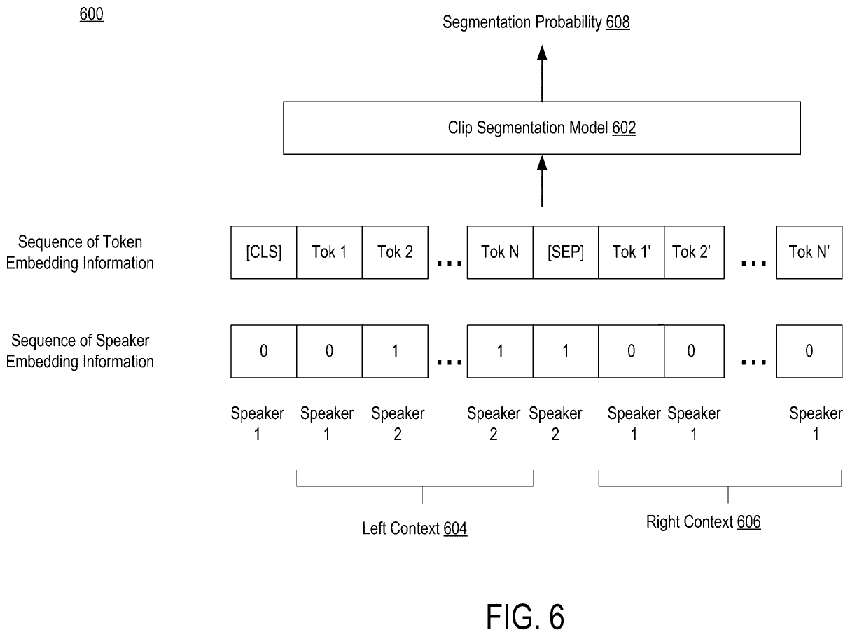

As shown in FIG. 1, processor 102 may include components for performing two phases, e.g., a training phase for training learning models (e.g., a neural network based classification model 302 as shown in FIG. 3, a clip segmentation model 602 as shown in FIG. 6, etc.) and a segmentation phase for performing multimodal video segmentation using the learning models. To perform the training phase, processor 102 may include a training module 109 or any other suitable component for performing the training function (e.g., a training database). To perform the segmentation phase, processor 102 may include a sentence segmentation module 105, a speaker change detector 106, and a video segmentation module 107. In some embodiments, processor 102 may include more or less of the components shown in FIG. 1. For example, when the learning models disclosed herein are pre-trained and provided, processor 102 may only include modules 105-107 (without training module 109).

Although FIG. 1 shows that sentence segmentation module 105, speaker change detector 106, video segmentation module 107, and training module 109 are within one processor 102, they may also be implemented on different processors located closely or remotely with each other. For example, training module 109 may be implemented by a processor (e.g., a GPU) dedicated to off-line training, and other modules 105-107 may be implemented by another processor for performing multimodal video segmentation.

Sentence segmentation module 105, speaker change detector 106, video segmentation module 107, and training module 109 (and any corresponding sub-modules or sub-units) can be hardware units (e.g., portions of an integrated circuit) of processor 102 designed for use with other components or software units implemented by processor 102 through executing at least part of a program. The program may be stored on a computer-readable medium, such as memory 103 or storage 104, and when executed by processor 102, it may perform one or more functions described herein.

Memory 103 and storage 104 may include any appropriate type of mass storage provided to store any type of information that processor 102 may need to operate. For example, memory 103 and storage 104 may be a volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory 103 and/or storage 104 may be configured to store one or more computer programs that may be executed by processor 102 to perform functions disclosed herein. For example, memory 103 and/or storage 104 may be configured to store program(s) that may be executed by processor 102 to perform multimodal video segmentation disclosed herein. Memory 103 and/or storage 104 may be further configured to store information and data used by processor 102.

Each data source 118 may include one or more storage devices configured to store videos (or video clips generated by system 101). The videos stored in data source 118 can be uploaded by users through user devices 112. Although FIG. 1 illustrates that system 101 and data source 118 are separate from each other, in some embodiments data source 118 and system 101 can be integrated into a single device.

User device 112 can be a computing device including a processor and a memory. For example, user device 112 can be a desktop computer, a laptop computer, a tablet computer, a smartphone, a game controller, a television (TV) set, a music player, a wearable electronic device such as a smart watch, an Internet-of-Things (IoT) appliance, a smart vehicle, or any other suitable electronic device with a processor and a memory. Although FIG. 1 illustrates that system 101 and user device 112 are separate from each other, in some embodiments user device 112 and system 101 can be integrated into a single device.

In some embodiments, a user may operate on user device 112 and may provide a user input through user device 112. User device 112 may send the user input to system 101 through network 110. The user input may include one or more parameters for performing multimodal video segmentation on a video. For example, the one or more parameters may include a title, one or more keywords, or a link of the video, so that system 101 can obtain the video from data source 118 using the title, the one or more keywords, or the link of the video.

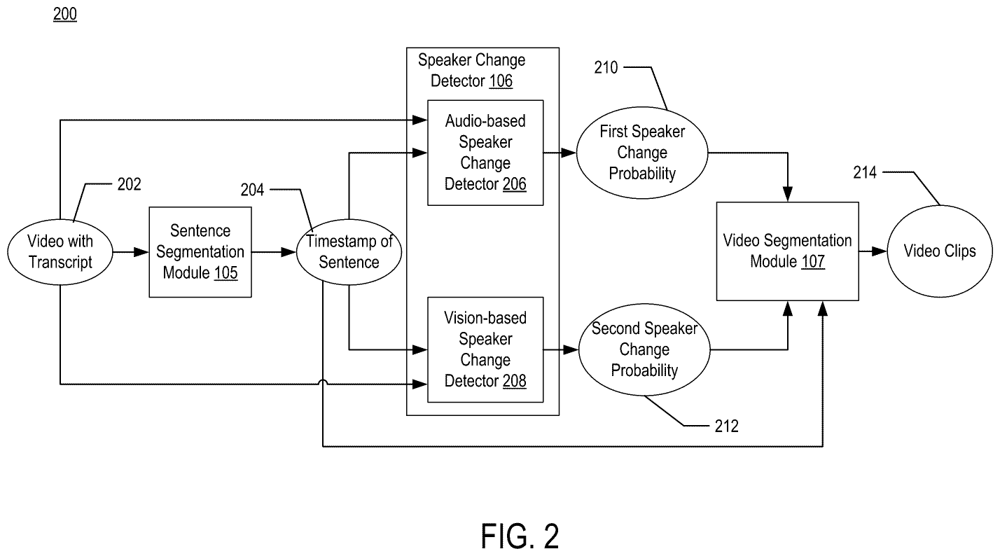

FIG. 2 is a schematic diagram illustrating an exemplary flow 200 of performing multimodal video segmentation in a multi-speaker scenario, according to embodiments of the disclosure. Initially, sentence segmentation module 105 may receive a video 202 with a transcript. Video 202 may have a plurality of speakers. The transcript may be generated through automatic speech recognition (ASR). Since the transcript is generated from ASR, there may be a plurality of paragraphs of pure text without punctuations in the transcript. It can be a challenge to perform text segmentation and speaker detection from these paragraphs of pure text. Sentence segmentation module 105 disclosed herein may apply a sentence segmentation model to segment these paragraphs into sentences in order to improve the accuracy of the segmentation of video 202.

Sentence segmentation module 105 may apply the sentence segmentation model to segment the transcript of the video into a plurality of sentences and to determine a plurality of timestamps 204 for the plurality of sentences, respectively. For example, by applying the sentence segmentation model, sentence segmentation module 105 may predict punctuations for the text in the transcript, and segment the text into a plurality of sentences based on the punctuations.

In some embodiments, the sentence segmentation model can be a sequence labeling model, which may add punctuations to pure text from the transcript and segment the text into sentences according to the punctuations. The text (e.g., paragraphs in the text) is firstly tokenized and split into smaller units such as individual words or terms, and each of the smaller units can be referred to as a token. For each token, its label is a punctuation (e.g., a period, an exclamation mark, a question mark, etc.) after it, or [NP] (e.g., no punctuation) if there is no punctuation after it.

In some embodiments, the sentence segmentation model can be implemented using a pre-trained Transformer model, which may include 24 encoder layers with a hidden size of 1024 and 16 attention heads. Given a paragraph of pure text, the paragraph can be tokenized into tokens. The sentence segmentation model takes the hidden state of each token from the last layer of the Transformer model, and then feeds the hidden state of each token into a linear classification layer over a punctuation label set. A Softmax function can be applied on the output logits. Cross entropy can be used as a loss function for the sentence segmentation model.

In some embodiments, training module 109 of FIG. 1 may be configured to train the sentence segmentation model. Random articles or any other types of articles from websites can be used as a training dataset. In order to make the training data close to real world ASR transcript text as much as possible, sentences in the articles can be combined into paragraphs and used as samples for the training as long as each of the paragraphs does not exceed a maximum sequence length of the model.

After segmenting the transcript of video 202 into a plurality of sentences, sentence segmentation module 105 may determine a plurality of timestamps 204 for the plurality of sentences, respectively. For example, sentence segmentation module 105 may determine a sentence start time and a sentence end time for each sentence, where a timestamp of the sentence may include at least one of the sentence start time or the sentence end time. The sentence start times and the sentence end times of the segmented sentences may provide precise timestamps for speaker change detector 106 and video segmentation module 107 as described below in more detail.

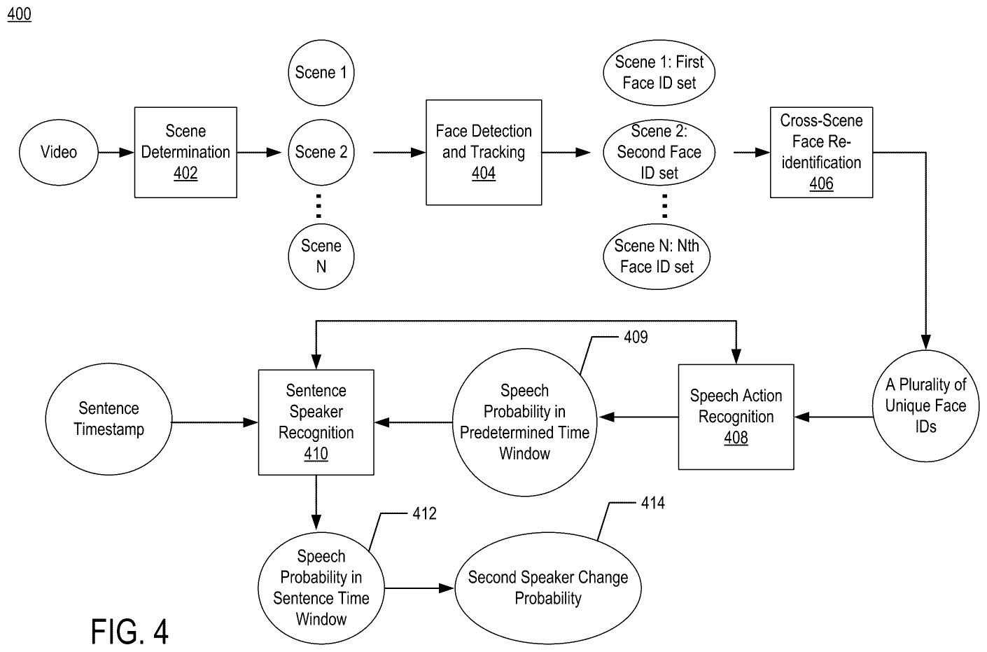

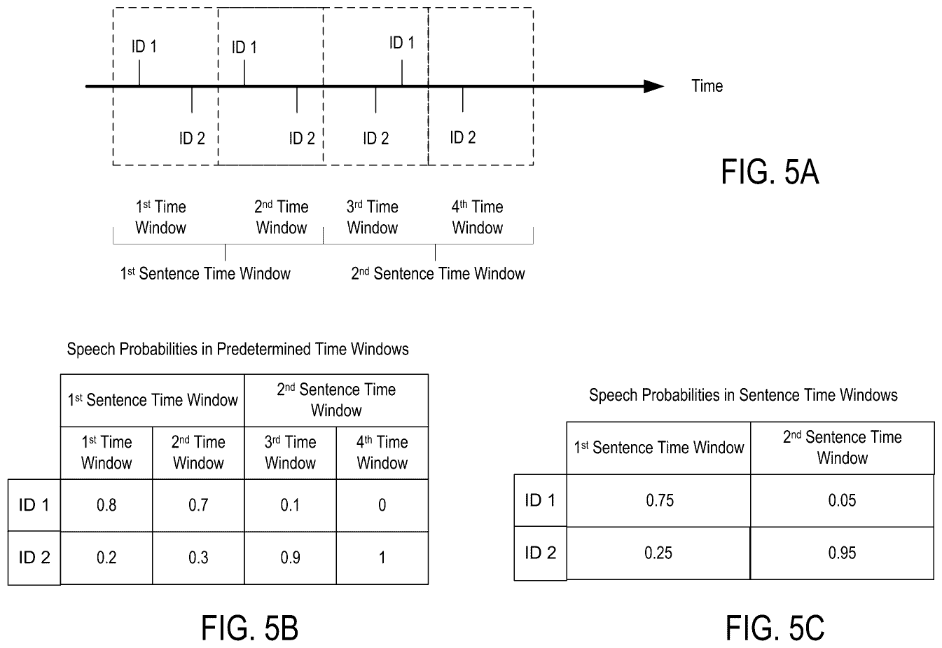

Next, speaker change detector 106 may be configured to detect speaker change information between each two adjacent sentences of the plurality of sentences based on at least one of audio content or visual content of the video. In some embodiments, speaker change detector 106 may include an audio-based speaker change detector 206 and a vision-based speaker change detector 208. Audio-based speaker change detector 206 may determine a respective first speaker change probability 210 between each two adjacent sentences based on the audio content of the video. Vision-based speaker change detector 208 may determine a respective second speaker change probability 212 between each two adjacent sentences based on the visual content of the video. The respective first and second speaker change probabilities 210, 212 between each two adjacent sentences may be aggregated to generate the speaker change information between each two adjacent sentences. Audio-based speaker change detector 206 is described below in more detail with reference to FIG. 3. Vision-based speaker change detector 208 is described below in more detail with reference to FIGS. 4-5C.

Subsequently, video segmentation module 107 may segment video 202 into a plurality of video clips 214 based on the transcript of video 202 and the speaker change information. For example, video segmentation module 107 may use the transcript and the speaker change information to segment video 202 into logically coherent video clips. Video segmentation module 107 is described below in more detail with reference to FIG. 6.

FIG. 3 illustrates a schematic diagram of audio-based speaker change detection 300, according to embodiments of the disclosure. To begin with, audio-based speaker change detector 206 may receive a plurality of timestamps for a plurality of sentences determined from a transcript of a video. For each two adjacent sentences, audio-based speaker change detector 206 may determine a time point t between the two adjacent sentences, and may obtain a set of acoustic features based on audio content of the video. For example, the set of acoustic features may include an input audio signal of the video which is truncated with a window of m seconds before and after the time point t. The set of acoustic features may be represented as Sₜ₋ₘ, . . . , Sₜ₋₂, Sₜ₋₁, Sₜ, Sₜ₊₁, Sₜ₊₂, . . . , Sₜ₊ₘ, with m being a window length parameter (e.g., m being an integer and m≥0). The set of acoustic features can be divided into two audio segments, with a first audio segment being a subset of the acoustic features within m seconds before the time point t, and a second audio segment being a subset of the acoustic features within m seconds after the time point t.

Audio-based speaker change detector 206 may generate a set of speaker embedding (e.g., denoted as Xₜ₋ₘ, . . . , Xₜ₋₂, Xₜ₋₁, Xₜ, Xₜ₊₁, Xₜ₊₂, . . . , Xₜ₊ₘ) based on the set of acoustic features. For example, audio-based change detector 206 may include a pre-trained speaker embedding module for generating the set of speaker embedding. It is contemplated that any type of speaker embedding can be used as an input to a neural network based classification model 302 described below, which is not limited to the types of speaker embedding disclosed herein.

In some embodiments, a time delay neural network (TDNN) classification model can be used to generate the set of speaker embedding. Specifically, an x-vector can be used to represent the speaker embedding. The TDNN classification model may include a TDNN structure used to produce x-vectors for the set of acoustic features. For example, the set of acoustic features may include frame-level audio features, and the TDNN structure may take the frame-level audio features as an input and gradually extract segmental features at higher layers in the network. The TDNN classification model may also include a statistical pooling layer and fully connected layers. The statistical pooling layer may be added to the TDNN structure for performing a mean and standard deviation pooling to aggregate speaker information from the entire input audio features into one single vector, which is then fed into the fully connected layers. An activation output from a final fully connected layer of the fully connected layers can be used to classify one or more speaker identifiers (IDs) for each input audio segment. After the TDNN classification model is trained, an activation output generated by the final fully connected layer can be used as the speaker embedding.

Audio-based speaker change detector 206 may feed the set of speaker embedding into neural network based classification model 302 to determine a first speaker change probability at the time point t between the two adjacent sentences. In some embodiments, neural network based classification model 302 may be a convolutional neural network (CNN) based binary classification model. Neural network based classification model 302 may be configured to detect, at any given time point t, whether speaker change occurs. Neural network based classification model 302 may include one or more convolutional layers 304, one or more dense layers 306, and an activation function 308 (e.g., a sigmoid activation function). For example, an output of the sigmoid activation function can be in a range between 0 and 1 and serve as the first speaker change probability at the time point t between the two adjacent sentences.

To train neural network based classification model 302, training module 109 may truncate audio data in a training dataset with a window of m seconds before and after a given time point, and perform operations like those described above to generate the corresponding speaker embedding. Training module 109 may use the generated corresponding speaker embedding as input to neural network based classification model 302. If there is speaker change happening at the given time point, a training target for the given time point can be 1. Otherwise, the training target can be 0.

In some embodiments, the window length parameter m can be changed so that neural network based classification model 302 can process different lengths of audio context. For example, when m=3, a balance between system latency and model accuracy can be achieved.

In some embodiments, neural network based classification model 302 may be implemented as a speaker diarization model configured to differentiate speakers in audio input. Despite the usefulness of sentence ending information provided by sentence segmentation module 105, it can be difficult to incorporate this information into the speaker diarization model. The speaker diarization model may generate inaccurate speaker boundaries and therefore results in higher numbers of misses and false alarms. Thus, the CNN based binary classification model described above is simpler but more robust than the speaker diarization model.

FIG. 4 illustrates a schematic diagram of vision-based speaker change detection 400, according to embodiments of the disclosure. Vision-based speaker change detection 400 may be performed to detect speaker change information in a video based on frames in the video. To begin with, vision-based speaker change detector 208 may perform scene determination 402 to determine a series of scenes in the video. For example, vision-based speaker change detector 208 may detect switching of scenes in the video and segment the video according to different scenes. The detected series of scenes may include, for example, Scene 1, Scene 2, . . . , and Scene N. The separated scenes can facilitate face detection and tracking 404, which is described below in more detail. For example, face detection and tracking 404 can be performed across multiple scenes in parallel so that an overall handling capacity can increase.

Vision-based speaker change detector 208 may perform face detection and tracking 404 to determine a face ID set in each of the scenes. For example, vision-based speaker change detector 208 may apply a face detection algorithm (e.g., YOLO) and a face tracking algorithm (e.g., Hungarian method) to output one or more face positions in each frame and a face ID set in each scene (e.g., a set of face IDs in each scene). As a result, a series of face ID sets can be determined for the series of scenes, respectively. For example, a first face ID set may be determined for Scene 1, a second face ID set may be determined for Scene 2, . . . , and an Nth face ID set may be determined for Scene N.

It is contemplated that even for the same speaker (e.g., each unique face) across different scenes, different face IDs may be detected for the same speaker in the different face ID sets since the different face ID sets are determined separately from one another. Then, vision-based speaker change detector 208 may perform cross-scene face re-identification 406 across the series of scenes to identify a plurality of unique face IDs from the series of face ID sets.

For example, vision-based speaker change detector 208 may union different face IDs of each unique face across the series of face ID sets to obtain a unique face ID for each unique face, so that a plurality of unique face IDs can be obtained from the series of face ID sets for a plurality of unique faces. The plurality of unique face IDs may be used to identify a plurality of speakers that appear in the video, with each speaker having a unique face identified by a unique face ID.

In a further example, for each face ID in the series of face ID sets, vision-based speaker change detector 208 may extract face features from a corresponding frame with the best quality. Then, vision-based speaker change detector 208 may compare face features of different face IDs and different scenes using a Non-Maximum Suppression (NMS) algorithm, and may union the face IDs to a corresponding unique face ID when a similarity value of the corresponding face features of the face IDs is greater than a threshold.

Vision-based speaker change detector 208 may perform speech action recognition 408 and sentence speaker recognition 410 together to determine a speech probability 412 for each speaker in each sentence window. Specifically, for each two adjacent sentences including a first sentence and a second sentence, vision-based speaker change detector 208 may determine that (a) the first sentence has a length of a first sentence time window and (b) the second sentence has a length of a second sentence time window based on timestamps of the first and second sentences.

Then, with respect to the first sentence time window, vision-based speaker change detector 208 may perform sentence speaker recognition 410 to determine, from the plurality of speakers, a first set of speakers that appear in the first sentence time window. For example, vision-based speaker change detector 208 may determine a first set of unique face IDs in the first sentence time window that identify the first set of speakers, respectively. Vision-based speaker change detector 208 may divide the first sentence time window into a first plurality of predetermined time windows. For each speaker in the first set of speakers, vision-based speaker change detector 208 may perform speech action recognition 408 to determine a respective speech probability 409 that the speaker speaks in each predetermined time window. As a result, a first plurality of speech probabilities 409 are determined for the speaker in the first plurality of predetermined time windows, respectively.

For example, for each unique face ID in the first set of unique face IDs, vision-based speaker change detector 208 may determine a speech probability 409 for a speaker identified by the unique face ID that speaks in each predetermined time window (e.g., 0.5 seconds). Specifically, for each predetermined time window, vision-based speaker change detector 208 may perform an end-to-end image recognition method to combine face features of the speaker in the predetermined time window. Vision-based speaker change detector 208 may feed the combined face features to a convolutional three-dimension (C3D) neural network or a temporal convolutional neural network (TCN) which outputs a speech probability 409 of the speaker that speaks in the predetermined time window. Alternatively or additionally, vision-based speaker change detector 208 may use face key points of the speaker to reduce computation complexity. For example, vision-based speaker change detector 208 may detect face key points of the speaker (e.g., lip key points, etc.), combine the face key points in the predetermined time window, and feed the combined face key points to a TCN network which outputs speech probability 409 of the speaker that speaks in the predetermined time window.

By performing similar operations for each predetermined time window, the first plurality of speech probabilities 409 can be determined for the speaker in the first plurality of predetermined time windows, respectively. Then, vision-based speaker change detector 208 may perform sentence speaker recognition 410 to determine a speech probability 412 for the speaker in the first sentence time window based on the first plurality of speech probabilities 409 determined for the speaker in the first plurality of predetermined time windows. For example, speech probability 412 for the speaker in the first sentence time window can be a weighted average of the first plurality of speech probabilities 409 determined for the speaker in the first plurality of predetermined time windows. By performing similar operations for each speaker present in the first sentence time window, vision-based speaker change detector 208 may determine a first set of speech probabilities 412 for the first set of speakers in the first sentence time window, respectively.

Similarly, with respect to the second sentence time window, vision-based speaker change detector 208 may perform sentence speaker recognition 410 to determine, from the plurality of speakers, a second set of speakers that appear in the second sentence time window. For example, vision-based speaker change detector 208 may determine a second set of unique face IDs in the second sentence time window that identify the second set of speakers, respectively. Vision-based speaker change detector 208 may divide the second sentence time window into a second plurality of predetermined time windows. For each speaker in the second set of speakers, vision-based speaker change detector 208 may perform speech action recognition 408 to determine a respective speech probability 409 that the speaker speaks in each predetermined time window. As a result, a second plurality of speech probabilities 409 are determined for the speaker in the second plurality of predetermined time windows, respectively. Then, vision-based speaker change detector 208 may perform sentence speaker recognition 410 to determine a speech probability 412 for the speaker in the second sentence time window based on the second plurality of speech probabilities 409 determined for the speaker in the second plurality of predetermined time windows. By performing similar operations for each speaker present in the second sentence time window, vision-based speaker change detector 208 may determine a second set of speech probabilities 412 for the second set of speakers in the second sentence time window, respectively.

Subsequently, vision-based speaker change detector 208 may determine a second speaker change probability 414 between the first and second sentences based on the first set of speech probabilities 412 in the first sentence time window and the second set of speech probabilities 412 in the second sentence time window. Two exemplary approaches for determining the second speaker change probability 414 between the first and second sentences are provided herein.

In a first exemplary approach, vision-based speaker change detector 208 may determine whether the first set of speakers speak in the first sentence time window based on the first set of speech probabilities 412, respectively. For example, if each of the first set of speech probabilities 412 is smaller than a threshold (e.g., 0.5), vision-based speaker change detector 208 may determine that no speaker speaks in the first sentence time window. In another example, vision-based speaker change detector 208 may determine a first speaker that has a highest speech probability 412 from the first set of speakers. If speech probability 412 of the first speaker is greater than or equal to the threshold, vision-based speaker change detector 208 may determine that the first speaker speaks in the first sentence time window. Otherwise (e.g., speech probability 412 of the first speaker is smaller than the threshold), vision-based speaker change detector 208 may determine that no speaker speaks in the first sentence time window.

By performing similar operations on the second set of speakers in the second sentence time window, vision-based speaker change detector 208 may also determine a second speaker that speaks in the second sentence time window. However, if each of the second set of speech probabilities 412 is smaller than the threshold, vision-based speaker change detector 208 may determine that no speaker speaks in the second sentence time window.

If the first speaker that speaks in the first sentence time window and the second speaker that speaks in the second sentence time window is the same speaker, vision-based speaker change detector 208 may determine that no speaker change occurs between the first and second sentences (e.g., second speaker change probability 414 between the first and second sentences is zero). If no speaker speaks in the first sentence time window and no speaker speaks in the second sentence time window, vision-based speaker change detector 208 may also determine that no speaker change occurs between the first and second sentences.

Alternatively, if the first speaker that speaks in the first sentence time window and the second speaker that speaks in the second sentence time window are different speakers, vision-based speaker change detector 208 may determine that speaker change occurs between the first and second sentences (e.g., second speaker change probability 414 between the first and second sentences is one). If there is no speaker speaking in the first sentence time window and a speaker speaking in the second sentence time window (or, there is a speaker speaking in the first sentence time window and no speaker speaking in the second sentence time window), vision-based speaker change detector 208 may also determine that speaker change occurs between the first and second sentences.

The above first exemplary approach is easy to implement. However, detection errors may occur especially when the first set of speech probabilities 412 or the second set of speech probabilities 412 is relatively low. Considering that speech probabilities that the same speaker speaks in continuous video segments have a certain degree of relevance (e.g., an event of a conditional probability), a second exemplary approach can be used to determine speaker change probability 414 using a Cartesian product between the speech probabilities in the continuous video segments. Compared with the first exemplary approach, the second exemplary approach has a better performance (e.g., with lower detection errors).

In the second exemplary approach, vision-based speaker change detector 208 may calculate a Cartesian product between (a) the first set of speech probabilities 412 for the first set of speakers in the first sentence time window and (b) the second set of speech probabilities 412 for the second set of speakers in the second sentence time window to determine a preliminary maximum same-speaker probability and a preliminary maximum speaker-change probability. An example on the calculation of the Cartesian product is illustrated below with reference to FIGS. 5A-5C. Then, vision-based speaker change detector 208 may determine second speaker change probability 414 between the first and second sentences based on the preliminary maximum same-speaker probability and the preliminary maximum speaker-change probability.

For example, if both the preliminary maximum same-speaker probability and the preliminary maximum speaker-change probability are smaller than a speech threshold (e.g., 0.5 or any other predetermined value), vision-based speaker change detector 208 may determine that it is unable to determine whether speaker change occurs between the two sentences. A probability that it is unable to determine whether speaker change occurs between the two sentences (denoted as I-unable) unable) can be calculated as follows:

$${p}_{u n a b l e} = \frac{τ}{M A X ( {p}_{same} , {p}_{change} ) + τ} . \qquad ( 1 )$$

In the above equation (1), τ denotes the speech threshold, pₛₐₘₑ denotes the preliminary maximum same-speaker probability, p_{change} denotes the preliminary maximum speaker-change probability, and MAX(pₛₐₘₑ, p_{change}) denotes a maximum of pₛₐₘₑ and p_{change}.

If at least one of the preliminary maximum same-speaker probability or the preliminary maximum speaker-change probability is not smaller than the speech threshold, vision-based speaker change detector 208 may determine speaker change probability 414 between the first and second sentences (denoted as p_{speaker-change}) as follows:

$${p}_{speaker - c h a n g e} = \frac{{p}_{change}}{{p}_{change} + {p}_{s a m e}} . \qquad ( 2 )$$

FIGS. 5A-5C illustrates an example of vision-based speaker change detection using the second exemplary approach, according to embodiments of the disclosure. FIG. 5A shows speakers that are identified to be present in a first sentence time window and a second sentence time window, respectively. For example, the first sentence time window is divided into a first predetermined time window and a second predetermined time window, and the second sentence time window is divided into a third predetermined time window and a fourth predetermined time window. A first speaker with a unique face ID 1 and a second speaker with a unique face ID 2 are identified to appear in the first and second predetermined time windows. The first speaker and the second speaker are also identified to appear in the third predetermined time window. Only the second speaker is identified to appear in the fourth predetermined time window. Thus, a first set of speakers in the first sentence time window includes the first speaker and the second speaker, and a second set of speakers in the second sentence time window also includes the first speaker and the second speaker.

FIG. 5B shows speech probabilities of the first speaker and the second speaker in the first to fourth predetermined time windows, respectively. FIG. 5C shows speech probabilities of the first speaker and the second speaker in the first and second sentence time windows, respectively. For example, referring to FIG. 5B, a speech probability of the first speaker in the first predetermined time window is p(ID1,1)=0.8, and a speech probability of the first speaker in the second predetermined time window is p(ID1,2)=0.7. Then, a speech probability of the first speaker in the first sentence time window (denoted as p_{sentence1, ID1}) can be an average of the speech probability of the first speaker in the first predetermined time window and the speech probability of the first speaker in the second predetermined time window. That is, p_{sentence1, ID1}=(p(ID1,1)+p(ID1,2))/2=0.75, as shown in FIG. 5C.

Also referring to FIG. 5B, a speech probability of the second speaker in the first predetermined time window is p(ID2,1)=0.2, and a speech probability of the second speaker in the second predetermined time window is p(ID2,2)=0.3. Then, a speech probability of the second speaker in the first sentence time window (denoted as p_{sentence1, ID2}) can be p_{sentence1, ID2}=(p(ID2,1)+p(ID2,2))/2=0.25, as shown in FIG. 5C.

Similarly, a speech probability of the first speaker in the second sentence time window (denoted as p_{sentence2, ID1}) can be obtained as p_{sentence2,}

$$ID 1 = \frac{p ( ID 1 , 3 ) + p ( ID 1 , 4 )}{2} = \frac{0.1 + 0}{2} = 0.05 ,$$

as shown in FIG. 5C. A speech probability of the second speaker in the second sentence time window (denoted as p_{sentence2, ID2}) can be obtained as p_{sentence2,}

$$ID 2 = \frac{p ( ID 2 , 3 ) + p ( ID 2 , 4 )}{2} = \frac{0.9 + 1}{2} = 0.95 ,$$

as shown in FIG. 5C.

Thus, a first set of speech probabilities for the first set of speakers in the first sentence time window includes p_{sentence1, ID1}=0.75 and p_{sentence1, ID2}=0.25. A second set of speech probabilities for the second set of speakers in the second sentence time window includes p_{sentence2, ID1}=0.05 and p_{sentence2, ID2}=0.95.

The Cartesian product between the first set of speech probabilities (denoted as A) and the second set of speech probabilities (denoted as B) can be calculated as follows:

A×B={(pₐ,p_{b})|aϵA,bϵB} (3).

In the above equation (3), A includes p_{sentence1, ID1} and p_{sentence1, ID2}. B includes p_{sentence2, ID1} and p_{sentence 2, ID2}. Then, the equation (3) can be rewritten as follows:

A×B={(p_{sentence1,ID1},p_{sentence2,ID1}),(p_{sentence1,ID1},p_{sentence2,ID2}),(p_{sentence1,ID2},p_{sentence2,ID1}),(p_{sentence2,ID2},p_{sentence2,ID2})} (4).

A preliminary same-speaker probability for the first and second sentences with respect to the first speaker (e.g., the same speaker being the first speaker) can be calculated as p_{sentence1, ID1}×p_{sentence2, ID1}. A preliminary same-speaker probability for the first and second sentences with respect to the second speaker (e.g., the same speaker being the second speaker) can be calculated as p_{sentence1, ID2}×p_{sentence2, ID2}. Then, a preliminary maximum same-speaker probability for the first and second sentences can be calculated as follows:

$${p}_{same} = MAX ( {p}_{sentence 1 , ID 1} \times {p}_{sentence 2 , ID 1} , {p}_{sentence 1 , ID 2} \times {p}_{sentence 2 , ID 2} ) \qquad ( 5 )$$

$$= MAX ( 0.75 \times 0.05 , 0.25 \times 0.95 ) = 0.2 375.$$

The same speaker in the preliminary maximum same-speaker probability of the above equation (5) is the second speaker.

A preliminary speaker-change probability for the first and second sentences with respect to the change from the first speaker to the second speaker can be calculated as p_{sentence1, ID1}×p_{sentence2, ID2}. A preliminary speaker-change probability for the first and second sentences with respect to the change from the second speaker to the first speaker can be calculated as p_{sentence1, ID2}×p_{sentence2, ID1}. Then, a preliminary maximum speaker-change probability for the first and second sentences can be calculated as follows:

$${p}_{change} = MAX ( {p}_{sentence 1 , ID 1} \times {p}_{sentence 2 , ID 2} , {p}_{sentence 1 , ID 2} \times {p}_{sentence 2 , ID 1} ) \qquad ( 6 )$$

$$= MAX ( 0.75 \times 0.95 , 0.25 \times 0.05 ) = 0.7125 .$$

The speaker change in the preliminary maximum speaker-change probability of the above equation (6) is from the first speaker to the second speaker.

Based on the above equation (2), a speaker change probability between the first and second sentences can be calculated as follows:

$${p}_{speaker - c h a n g e} = \frac{{p}_{change}}{{p}_{change} + {p}_{s a m e}} = \frac{0.7125}{0.7125 + 0.2375} = 0 \text{.75} . \qquad ( 7 )$$

That is, the speaker change probability between the first and second sentences is 0.75, which is a probability changed from the first speaker to the second speaker.

FIG. 6 illustrates a schematic diagram of video segmentation 600 on a video based on speaker change information, according to embodiments of the disclosure. Video segmentation module 107 may tokenize text in a transcript of the video into a plurality of tokens. Video segmentation module 107 may receive respective first and second speaker change probabilities between each two adjacent sentences from audio-based speaker change detector 206 and vision-based speaker change detector 208, respectively. Video segmentation module 107 may combine the respective first and second speaker change probabilities between each two adjacent sentences to generate an aggregated speaker change probability for the two adjacent sentences. For example, the aggregated speaker change probability can be a weighted average of the respective first and second speaker change probabilities between the two adjacent sentences. As a result, a plurality of aggregated speaker change probabilities associated with the plurality of sentences are generated for the video. Then, video segmentation module 107 may segment the video into a plurality of video clips based on the plurality of aggregated speaker change probabilities and the plurality of tokens, as described below in more detail.

To begin with, video segmentation module 107 may determine a plurality of candidate break points for clipping the video. For example, a candidate break point can be a time point between two adjacent sentence time windows in the video. Other types of candidate break points are also possible.

Next, for each candidate break point, video segmentation module 107 may determine (a) a first context 604 preceding to the candidate break point and (b) a second context 606 subsequent to the candidate break point based on the plurality of aggregated speaker change probabilities and the plurality of tokens.

In some embodiments, video segmentation module 107 may determine, based on the plurality of tokens, (a) first token embedding information in a first time window preceding to the candidate break point and (b) second token embedding information in a second time window subsequent to the candidate break point. With reference to FIG. 6, for a given candidate break point marked with a separation token (e.g., [SEP]), an input sequence of token embedding information may begin with a [CLS] token, which represents overall information of the input sequence. The input sequence of token embedding information may include the first token embedding information (e.g., Tok 1, Tok 2, . . . , Tok N) and the second token embedding information (e.g., Tok 1′, Tok 2′, . . . , Tok N′). The first token information and the second token information are separated by the [SEP] token. In some embodiments, the input sequence of token embedding information may be padded with [PAD] tokens to the end of the input sequence.

In some embodiments, video segmentation module 107 may determine, based on the plurality of aggregated speaker change probabilities, first speaking embedding information in the first time window and second speaker embedding information in the second time window. For example, a sequence of speaker embedding information may be generated by using a segment embedding layer in a pre-trained model. Since the segment embedding layer takes binary inputs and the number of speakers is different from video to video, the sequence of speaker embedding information may also encode speakers in a binary way.

For example, for a first speaker (Speaker 1), a speaker ID in the sequence of speaker embedding information is initialized to 0. When a speaker change occurs at a time point of a particular token, the speaker ID at the particular token is changed to 1—speaker ID. That is, the speaker ID switches between 0 and 1 when the speaker change occurs, where the speaker change can be detected based on a corresponding aggregated speaker change probability. For example, if a time point of a particular token is a time point between two adjacent sentence time windows, and an aggregated speaker change probability at the time point is equal to or greater than a threshold such as 0.5, speaker change occurs and the speaker ID at the particular token is changed to 1—speaker ID. In another example, if a time point of a particular token is not a time point between two adjacent sentence time windows (or an aggregated speaker change probability at the time point is smaller than the threshold), speaker change does not occur and the speaker ID at the particular token is unchanged.

In a further example with reference to FIG. 6, an initial speaker is Speaker 1, and a speaker ID is firstly initialized to 0. At a time point of the token “Tok 1,” the speaker is still Speaker 1 (e.g., no speaker change occurs), and the speaker ID maintains to be 0. At a time point of the token “Tok 2,” an aggregated speaker change probability at the time point is greater than the threshold, and speaker change occurs at the time point (e.g., the speaker is changed from Speaker 1 to Speaker 2). Then, the speaker ID at the token “Tok 2” is changed to 1—speaker ID=1−0=1.

Also with reference to FIG. 6, the sequence of speaker embedding information may include first speaker embedding information, which includes speaker IDs in the first time window before the candidate break point [SEP] (e.g., 0, 1, . . . , 1). The sequence of speaker embedding information may also include second speaker embedding information, which includes speaker IDs in the second time window after the candidate break point [SEP] (e.g., 0, 0, . . . , 0).

In some embodiments, video segmentation module 107 may generate first context 604 to include the first token embedding information and the first speaker embedding information. Video segmentation module 107 may also generate second context 606 to include the second token embedding information and the second speaker embedding information.

Subsequently, video segmentation module 107 may feed first context 604 and second context 606 to a clip segmentation model 602 to determine a segmentation probability 608 at the candidate break point [SEP]. Clip segmentation model 602 may operate on a single candidate break point, and may treat each candidate break point and left and right contexts of the candidate break point together as a sample. An input layer of clip segmentation model 602 may include both the sequence of token embedding information and the sequence of speaker embedding information.

In clip segmentation model 602, a final hidden vector Cϵ [symbol] ^{H} corresponding to the first input token [CLS] may be used as an aggregate representation. After a linear classification layer Wϵ [symbol] ^{2×H}, a Softmax function can be applied to C and W to obtain segmentation probability 608 for this candidate break point. In some embodiments, if segmentation probability 608 is greater than a predetermined threshold (e.g., a threshold τ), video segmentation module 107 may determine the candidate break point to be a clip boundary point so that the video is clipped at the clip boundary point. In some embodiments, clip segmentation model 602 can be implemented using a RoBERTa-Large model, which may include 24 encoder layers with a hidden size of 1024 and 16 attention heads.

During training of clip segmentation model 602, an average cross-entropy error over N samples of candidate break points can be calculated as follows:

$$Error = \frac{1}{N} {\sum }_{i = 1}^{N} ( - {y}_{i} log {p}_{i} - ( 1 - {y}_{i} ) log ( 1 - {p}_{i} ) ) . \qquad ( 8 )$$

In the above equation (8), yᵢ is equal to either 0 or 1. yᵢ=1 indicates that the video is segmented at a candidate break point i with a segmentation probability pᵢ. yᵢ=0 indicates that the video is not segmented at the candidate break point i with a probability 1−pᵢ.

During a test of clip segmentation model 602, the model may take each break in a document as a sample of a candidate break point (e.g., except the last break in the document), and may return a corresponding segmentation probability for each break. The corresponding segmentation probability may be used to determine whether the break is a segmentation boundary of the video. As a result, segmentation probabilities for all the breaks in the document can be determined. Then, the segmentation probabilities of all the breaks in the document can be compared with the threshold τ. Only breaks with segmentation probabilities greater than the threshold τ are kept and determined to be segmentation boundaries for the video. For example, the breaks with segmentation probabilities greater than the threshold τ are determined to be clip boundary points for clipping the video. The threshold τ is optimized on a validation set, and an optimal value for the threshold τ can be used in testing.

In some embodiments, if there are consecutive segmentation boundaries with segmentation probabilities greater than the threshold τ, only the segmentation boundary with the largest segmentation probability among the consecutive segmentation boundaries is selected as the clip boundary point. This is because breaks near a true segmentation boundary are likely to be predicted as segmentation boundaries, whereas only the break with the highest segmentation probability is more likely to be the true segmentation boundary.

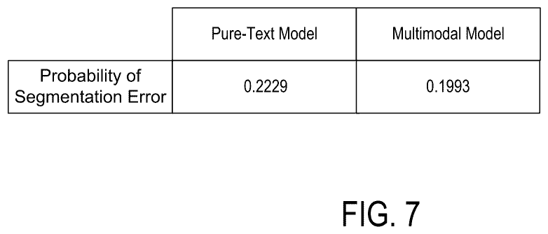

FIG. 7 is a graphical representation illustrating exemplary performance of multimodal video segmentation in a multi-speaker scenario, according to embodiments of the disclosure. The multimodal video segmentation disclosed herein can be evaluated using a meeting corpus dataset which includes a collection of 75 meetings with speaker labels and segmentation labels. The meetings each may include 3 to 10 participants (e.g., with an average of 6 participants). The dataset is split into a training set, a validation set, and a test set randomly in a ratio as 61/7/7. A Pₖ metric, which uses sliding windows to compute a probability of segmentation error, is applied herein to evaluate the performance. For a window of a fixed width k over sentences, it is determined whether a sentence at the boundaries of the window belongs to the same segment in the reference, and an error is counted if not. After moving the window across the document, an average error rate is calculated. Thus, a lower Pₖ indicates a better performance. The window size k can be set as a half of an average length of segments in the reference segmentation.

FIG. 7 shows results from experiments on a meeting corpus test dataset, which includes a collection of numerous meetings with speaker labels and segmentation labels. The multimodal video segmentation disclosed herein is compared to a pure-text model which only uses transcripts as input. The multimodal video segmentation disclosed herein can reduce the relative error from the pure-text model by 10.6% on the dataset. The experiment results show that the incorporation of speaker information in the multimodal video segmentation disclosed herein can improve the video clipping performance in multi-speaker scenarios.

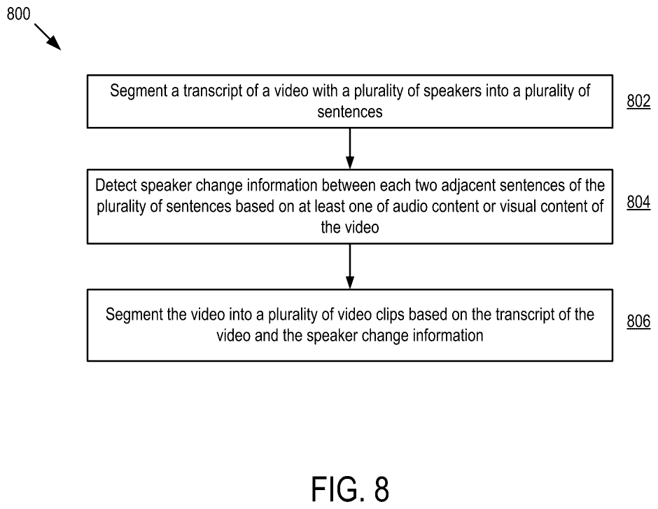

FIG. 8 is a flowchart of an exemplary method 800 for performing multimodal video segmentation in a multi-speaker scenario, according to embodiments of the disclosure. Method 800 may be implemented by system 101, specifically sentence segmentation module 105, speaker change detector 106, and video segmentation module 107, and may include steps 502-506 as described below. Some of the steps may be optional to perform the disclosure provided herein. Further, some of the steps may be performed simultaneously, or in a different order than that shown in FIG. 8.

At step 502, a transcript of a video with a plurality of speakers is segmented into a plurality of sentences.

At step 504, speaker change information is detected between each two adjacent sentences of the plurality of sentences based on at least one of audio content or visual content of the video.

At step 506, the video is segmented into a plurality of video clips based on the transcript of the video and the speaker change information.

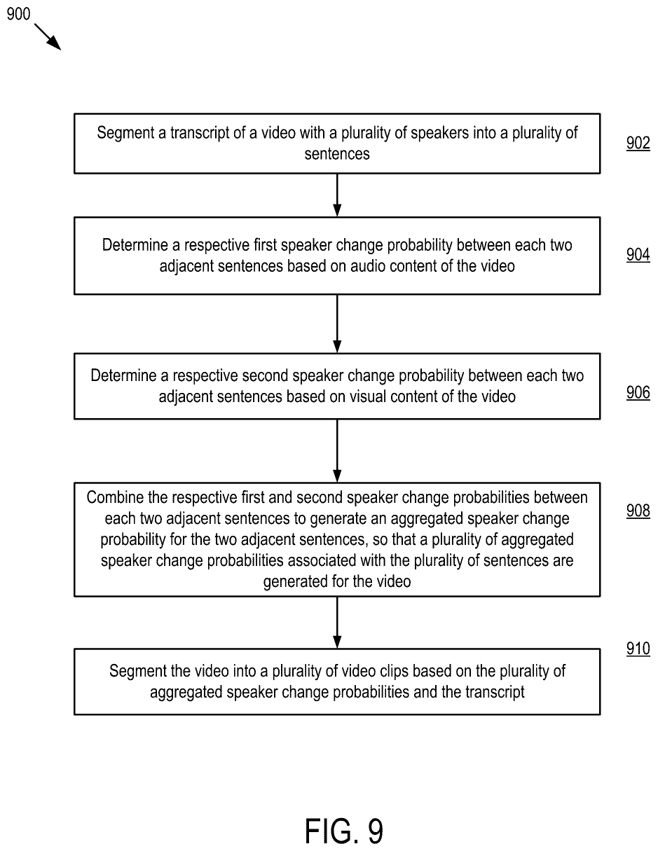

FIG. 9 is a flowchart of another exemplary method 900 for performing multimodal video segmentation in a multi-speaker scenario, according to embodiments of the disclosure. Method 900 may be implemented by system 101, specifically sentence segmentation module 105, speaker change detector 106, and video segmentation module 107, and may include steps 902-910 as described below. Some of the steps may be optional to perform the disclosure provided herein. Further, some of the steps may be performed simultaneously, or in a different order than that shown in FIG. 9.

At step 902, a transcript of a video with a plurality of speakers is segmented into a plurality of sentences.

At step 904, a respective first speaker change probability between each two adjacent sentences is determined based on audio content of the video.

At step 906, a respective second speaker change probability between each two adjacent sentences is determined based on visual content of the video.

At step 908, the respective first and second speaker change probabilities between each two adjacent sentences are combined to generate an aggregated speaker change probability for the two adjacent sentences. As a result, a plurality of aggregated speaker change probabilities associated with the plurality of sentences are generated for the video.

At step 910, the video is segmented into a plurality of video clips based on the plurality of aggregated speaker change probabilities and the transcript.

Consistent with the present disclosure, a multimodal video segmentation system and method are disclosed herein to generate short video clips from multi-speaker videos automatically. In the system and method disclosed herein, sentence segmentation module 105 provides precise sentence timestamps to speaker change detector 106 and video segmentation module 107. Speaker change detector 106 utilizes both audio modality and video modality to detect a speaker for each sentence. Video segmentation module 107 processes a transcript of the video and speaker information to predict video clip boundaries. Experiments show that the system and method disclosed herein can improve the video clipping performance in multi-speaker scenarios.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

According to one aspect of the present disclosure, a system for multimodal video segmentation in a multi-speaker scenario is disclosed. The system includes a memory configured to store instructions and a processor coupled to the memory and configured to execute the instructions to perform a process. The process includes segmenting a transcript of a video with a plurality of speakers into a plurality of sentences. The process further includes detecting speaker change information between each two adjacent sentences of the plurality of sentences based on at least one of audio content or visual content of the video. The process further includes segmenting the video into a plurality of video clips based on the transcript of the video and the speaker change information.

In some embodiments, to segment the transcript of the video, the processor is further configured to: predict punctuations for text in the transcript; segment the text into the plurality of sentences based on the punctuations; and determine a plurality of timestamps for the plurality of sentences, respectively.

In some embodiments, to detect the speaker change information, the processor is further configured to determine a respective first speaker change probability between each two adjacent sentences based on the audio content of the video.

In some embodiments, to determine the respective first speaker change probability, the processor is further configured to: obtain a set of acoustic features based on the audio content of the video and a time point between the two adjacent sentences; generate a set of speaker embedding based on the set of acoustic features; and feed the set of speaker embedding into a neural network based classification model to determine the respective first speaker change probability at the time point between the two adjacent sentences.

In some embodiments, the neural network based classification model includes a CNN based binary classification model.

In some embodiments, to detect the speaker change information, the processor is further configured to determine a respective second speaker change probability between each two adjacent sentences based on the visual content of the video.

In some embodiments, to determine the respective second speaker change probability, the processor is further configured to identify the plurality of speakers that appear in the video, where the plurality of speakers are identified by a plurality of unique face IDs.

In some embodiments, to identify the plurality of speakers that appear in the video, the processor is further configured to: determine a series of scenes in the video; perform face detection and tracking to determine a face ID set in each of the scenes, so that a series of face ID sets are determined for the series of scenes, respectively; and perform cross-scene face re-identification across the series of scenes to identify the plurality of unique face IDs from the series of face ID sets.

In some embodiments, to determine the respective second speaker change probability, the processor is further configured to: for each two adjacent sentences including a first sentence and a second sentence, determine a first set of speech probabilities for a first set of speakers that appear in the video within a first sentence time window associated with the first sentence, respectively; determine a second set of speech probabilities for a second set of speakers that appear in the video within a second sentence time window associated with the second sentence, respectively; and determine the respective second speaker change probability between the first and second sentences based on the first set of speech probabilities and the second set of speech probabilities.

In some embodiments, the processor is further configured to: perform a sentence speaker recognition process to determine, from the plurality of speakers, the first set of speakers that appear in the first sentence time window; and perform the sentence speaker recognition process to determine, from the plurality of speakers, the second set of speakers that appear in the second sentence time window.

In some embodiments, to determine the first set of speech probabilities for the first set of speakers, respectively, the processor is further configured to: divide the first sentence time window into a plurality of predetermined time windows; and for each speaker in the first set of speakers, perform a speech action recognition process to determine a respective probability that the speaker speaks in each predetermined time window, so that a plurality of probabilities are determined for the speaker in the plurality of predetermined time windows, respectively; and determine a speech probability for the speaker in the first sentence time window based on the plurality of probabilities determined for the speaker in the plurality of predetermined time windows.

In some embodiments, to determine the respective second speaker change probability between the first and second sentences, the processor is further configured to: calculate a Cartesian product between the first set of speech probabilities for the first set of speakers in the first sentence time window and the second set of speech probabilities for the second set of speakers in the second sentence time window to determine a preliminary maximum same-speaker probability and a preliminary maximum speaker-change probability; and determine the respective second speaker change probability between the first and second sentences based on the preliminary maximum same-speaker probability and the preliminary maximum speaker-change probability.

In some embodiments, to segment the video into the plurality of video clips, the processor is further configured to: tokenize the text in the transcript into a plurality of tokens; combine the respective first and second speaker change probabilities between each two adjacent sentences to generate an aggregated speaker change probability for the two adjacent sentences, so that a plurality of aggregated speaker change probabilities associated with the plurality of sentences are generated for the video; and segment the video into the plurality of video clips based on the plurality of aggregated speaker change probabilities and the plurality of tokens.

In some embodiments, to segment the video into the plurality of video clips based on the plurality of aggregated speaker change probabilities and the plurality of tokens, the processor is further configured: determine a plurality of candidate break points for clipping the video; and for each candidate break point, determine a first context preceding to the candidate break point and a second context subsequent to the candidate break point based on the plurality of aggregated speaker change probabilities and the plurality of tokens; feed the first and second contexts to a clip segmentation model to determine a segmentation probability at the candidate break point; and responsive to the segmentation probability being greater than a predetermined threshold, determine the candidate break point to be a clip boundary point so that the video is clipped at the clip boundary point.

In some embodiments, to determine the first context preceding the candidate break point and the second context subsequent to the candidate break point, the processor is further configured to: determine, based on the plurality of tokens, first token embedding information in a first time window preceding to the candidate break point and second token embedding information in a second time window subsequent to the candidate break point; determine, based on the plurality of aggregated speaker change probabilities, first speaking embedding information in the first time window and second speaker embedding information in the second time window; generate the first context to include the first token embedding information and the first speaker embedding information; and generate the second context to include the second token embedding information and the second speaker embedding information.

According to another aspect of the present disclosure, a method for multimodal video segmentation in a multi-speaker scenario is disclosed. A transcript of a video with a plurality of speakers is segmented into a plurality of sentences. Speaker change information between each two adjacent sentences of the plurality of sentences is detected based on at least one of audio content or visual content of the video. The video is segmented into a plurality of video clips based on the transcript of the video and the speaker change information.

In some embodiments, segmenting the transcript of the video includes: predicting punctuations for text in the transcript; segmenting the text into the plurality of sentences based on the punctuations; and determining a plurality of timestamps for the plurality of sentences, respectively.

In some embodiments, detecting the speaker change information includes determining a respective first speaker change probability between each two adjacent sentences based on the audio content of the video.

In some embodiments, determining the respective first speaker change probability includes: obtaining a set of acoustic features based on the audio content of the video and a time point between the two adjacent sentences; generating a set of speaker embedding based on the set of acoustic features; and feeding the set of speaker embedding into a neural network based classification model to determine the respective first speaker change probability at the time point between the two adjacent sentences.

In some embodiments, the neural network based classification model includes a CNN based binary classification model.

In some embodiments, detecting the speaker change information further includes determining a respective second speaker change probability between each two adjacent sentences based on the visual content of the video.

In some embodiments, determining the respective second speaker change probability includes identifying the plurality of speakers that appear in the video, where the plurality of speakers are identified by a plurality of unique face IDs.

In some embodiments, identifying the plurality of speakers that appear in the video includes: determining a series of scenes in the video; performing face detection and tracking to determine a face ID set in each of the scenes, so that a series of face ID sets are determined for the series of scenes, respectively; and performing cross-scene face re-identification across the series of scenes to identify the plurality of unique face IDs from the series of face ID sets.

In some embodiments, determining the respective second speaker change probability includes: for each two adjacent sentences including a first sentence and a second sentence, determining a first set of speech probabilities for a first set of speakers that appear in the video within a first sentence time window associated with the first sentence, respectively; determining a second set of speech probabilities for a second set of speakers that appear in the video within a second sentence time window associated with the second sentence, respectively; and determining the respective second speaker change probability between the first and second sentences based on the first set of speech probabilities and the second set of speech probabilities.

In some embodiments, a sentence speaker recognition process is performed to determine, from the plurality of speakers, the first set of speakers that appear in the first sentence time window. The sentence speaker recognition process is performed to determine, from the plurality of speakers, the second set of speakers that appear in the second sentence time window.

In some embodiments, determining the first set of speech probabilities for the first set of speakers, respectively, includes: dividing the first sentence time window into a plurality of predetermined time windows; and for each speaker in the first set of speakers, performing a speech action recognition process to determine a respective probability that the speaker speaks in each predetermined time window, so that a plurality of probabilities are determined for the speaker in the plurality of predetermined time windows, respectively; and determining a speech probability for the speaker in the first sentence time window based on the plurality of probabilities determined for the speaker in the plurality of predetermined time windows.

In some embodiments, determining the respective second speaker change probability between the first and second sentences includes: calculating a Cartesian product between the first set of speech probabilities for the first set of speakers in the first sentence time window and the second set of speech probabilities for the second set of speakers in the second sentence time window to determine a preliminary maximum same-speaker probability and a preliminary maximum speaker-change probability; and determining the respective second speaker change probability between the first and second sentences based on the preliminary maximum same-speaker probability and the preliminary maximum speaker-change probability.

In some embodiments, segmenting the video into the plurality of video clips includes: tokenizing the text in the transcript into a plurality of tokens; combining the respective first and second speaker change probabilities between each two adjacent sentences to generate an aggregated speaker change probability for the two adjacent sentences, so that a plurality of aggregated speaker change probabilities associated with the plurality of sentences are generated for the video; and segmenting the video into the plurality of video clips based on the plurality of aggregated speaker change probabilities and the plurality of tokens.

In some embodiments, segmenting the video into the plurality of video clips based on the plurality of aggregated speaker change probabilities and the plurality of tokens includes: determining a plurality of candidate break points for clipping the video; and for each candidate break point, determining a first context preceding to the candidate break point and a second context subsequent to the candidate break point based on the plurality of aggregated speaker change probabilities and the plurality of tokens; feeding the first and second contexts to a clip segmentation model to determine a segmentation probability at the candidate break point; and responsive to the segmentation probability being greater than a predetermined threshold, determining the candidate break point to be a clip boundary point so that the video is clipped at the clip boundary point.

In some embodiments, determining the first context preceding the candidate break point and the second context subsequent to the candidate break point includes: determining, based on the plurality of tokens, first token embedding information in a first time window preceding to the candidate break point and second token embedding information in a second time window subsequent to the candidate break point; determining, based on the plurality of aggregated speaker change probabilities, first speaking embedding information in the first time window and second speaker embedding information in the second time window; generating the first context to include the first token embedding information and the first speaker embedding information; and generating the second context to include the second token embedding information and the second speaker embedding information.

According to yet another aspect of the present disclosure, a non-transitory computer-readable storage medium is disclosed. The non-transitory computer-readable storage medium is configured to store instructions which, in response to an execution by a processor, cause the processor to perform a process. The process includes segmenting a transcript of a video with a plurality of speakers into a plurality of sentences. The process further includes detecting speaker change information between each two adjacent sentences of the plurality of sentences based on at least one of audio content or visual content of the video. The process further includes segmenting the video into a plurality of video clips based on the transcript of the video and the speaker change information.

The foregoing description of the specific implementations can be readily modified and/or adapted for various applications. Therefore, such adaptations and modifications are intended to be within the meaning and range of equivalents of the disclosed implementations, based on the teaching and guidance presented herein. The breadth and scope of the present disclosure should not be limited by any of the above-described exemplary implementations, but should be defined only in accordance with the following claims and their equivalents.

What is claimed is:

1. A system for multimodal video segmentation in a multi-speaker scenario, comprising:
a memory configured to store instructions; and
a processor coupled to the memory and configured to execute the instructions to perform a process comprising:
segmenting a transcript of a video with a plurality of speakers into a plurality of sentences;
detecting speaker change information between each two adjacent sentences of the plurality of sentences based on at least one of audio content or visual content of the video; and
segmenting the video into a plurality of video clips based on the transcript of the video and the speaker change information.

2. The system of claim 1, wherein to segment the transcript of the video, the processor is further configured to:
predict punctuations for text in the transcript;
segment the text into the plurality of sentences based on the punctuations; and
determine a plurality of timestamps for the plurality of sentences, respectively.

3. The system of claim 1, wherein to detect the speaker change information, the processor is further configured to:
determine a respective first speaker change probability between each two adjacent sentences based on the audio content of the video.

4. The system of claim 3, wherein to determine the respective first speaker change probability, the processor is further configured to:
obtain a set of acoustic features based on the audio content of the video and a time point between the two adjacent sentences;
generate a set of speaker embedding based on the set of acoustic features; and
feed the set of speaker embedding into a neural network based classification model to determine the respective first speaker change probability at the time point between the two adjacent sentences.

5. The system of claim 4, wherein the neural network based classification model comprises a convolutional neural network (CNN) based binary classification model.

6. The system of claim 3, wherein to detect the speaker change information, the processor is further configured to:
determine a respective second speaker change probability between each two adjacent sentences based on the visual content of the video.

7. The system of claim 6, wherein to determine the respective second speaker change probability, the processor is further configured to:
identify the plurality of speakers that appear in the video, wherein the plurality of speakers are identified by a plurality of unique face identifiers (IDs).

8. The system of claim 7, wherein to identify the plurality of speakers that appear in the video, the processor is further configured to:
determine a series of scenes in the video;
perform face detection and tracking to determine a face ID set in each of the scenes, so that a series of face ID sets are determined for the series of scenes, respectively; and
perform cross-scene face re-identification across the series of scenes to identify the plurality of unique face IDs from the series of face ID sets.

9. The system of claim 7, wherein to determine the respective second speaker change probability, the processor is further configured to:
for each two adjacent sentences comprising a first sentence and a second sentence,
determine a first set of speech probabilities for a first set of speakers that appear in the video within a first sentence time window associated with the first sentence, respectively;
determine a second set of speech probabilities for a second set of speakers that appear in the video within a second sentence time window associated with the second sentence, respectively; and
determine the respective second speaker change probability between the first and second sentences based on the first set of speech probabilities and the second set of speech probabilities.

10. The system of claim 9, wherein the processor is further configured to:
perform a sentence speaker recognition process to determine, from the plurality of speakers, the first set of speakers that appear in the first sentence time window; and
perform the sentence speaker recognition process to determine, from the plurality of speakers, the second set of speakers that appear in the second sentence time window.

11. The system of claim 9, wherein to determine the first set of speech probabilities for the first set of speakers, respectively, the processor is further configured to:
divide the first sentence time window into a plurality of predetermined time windows; and
for each speaker in the first set of speakers,
perform a speech action recognition process to determine a respective probability that the speaker speaks in each predetermined time window, so that a plurality of probabilities are determined for the speaker in the plurality of predetermined time windows, respectively; and
determine a speech probability for the speaker in the first sentence time window based on the plurality of probabilities determined for the speaker in the plurality of predetermined time windows.

12. The system of claim 9, wherein to determine the respective second speaker change probability between the first and second sentences, the processor is further configured to:
calculate a Cartesian product between the first set of speech probabilities for the first set of speakers in the first sentence time window and the second set of speech probabilities for the second set of speakers in the second sentence time window to determine a preliminary maximum same-speaker probability and a preliminary maximum speaker-change probability; and
determine the respective second speaker change probability between the first and second sentences based on the preliminary maximum same-speaker probability and the preliminary maximum speaker-change probability.

13. The system of claim 6, wherein to segment the video into the plurality of video clips, the processor is further configured to:
tokenize the text in the transcript into a plurality of tokens;
combine the respective first and second speaker change probabilities between each two adjacent sentences to generate an aggregated speaker change probability for the two adjacent sentences, so that a plurality of aggregated speaker change probabilities associated with the plurality of sentences are generated for the video; and
segment the video into the plurality of video clips based on the plurality of aggregated speaker change probabilities and the plurality of tokens.

14. The system of claim 13, wherein to segment the video into the plurality of video clips based on the plurality of aggregated speaker change probabilities and the plurality of tokens, the processor is further configured:
determine a plurality of candidate break points for clipping the video; and
for each candidate break point,
determine a first context preceding to the candidate break point and a second context subsequent to the candidate break point based on the plurality of aggregated speaker change probabilities and the plurality of tokens;
feed the first and second contexts to a clip segmentation model to determine a segmentation probability at the candidate break point; and
responsive to the segmentation probability being greater than a predetermined threshold, determine the candidate break point to be a clip boundary point so that the video is clipped at the clip boundary point.

15. The system of claim 14, wherein to determine the first context preceding the candidate break point and the second context subsequent to the candidate break point, the processor is further configured to:
determine, based on the plurality of tokens, first token embedding information in a first time window preceding to the candidate break point and second token embedding information in a second time window subsequent to the candidate break point;
determine, based on the plurality of aggregated speaker change probabilities, first speaking embedding information in the first time window and second speaker embedding information in the second time window;
generate the first context to include the first token embedding information and the first speaker embedding information; and
generate the second context to include the second token embedding information and the second speaker embedding information.

16. A method for multimodal video segmentation in a multi-speaker scenario, comprising:
segmenting a transcript of a video with a plurality of speakers into a plurality of sentences;
detecting speaker change information between each two adjacent sentences of the plurality of sentences based on at least one of audio content or visual content of the video; and
segmenting the video into a plurality of video clips based on the transcript of the video and the speaker change information.

17. The method of claim 16, wherein segmenting the transcript of the video comprises:
predicting punctuations for text in the transcript;
segmenting the text into the plurality of sentences based on the punctuations; and
determining a plurality of timestamps for the plurality of sentences, respectively.

18. The method of claim 16, wherein detecting the speaker change information comprises:
determining a respective first speaker change probability between each two adjacent sentences based on the audio content of the video.

19. The method of claim 18, wherein determining the respective first speaker change probability comprises:
obtaining a set of acoustic features based on the audio content of the video and a time point between the two adjacent sentences;
generating a set of speaker embedding based on the set of acoustic features; and
feeding the set of speaker embedding into a neural network based classification model to determine the respective first speaker change probability at the time point between the two adjacent sentences.

20. A non-transitory computer-readable storage medium configured to store instructions which, in response to an execution by a processor, cause the processor to perform a process comprising:
segmenting a transcript of a video with a plurality of speakers into a plurality of sentences;
detecting speaker change information between each two adjacent sentences of the plurality of sentences based on at least one of audio content or visual content of the video; and
segmenting the video into a plurality of video clips based on the transcript of the video and the speaker change information.
